(19) United States
(12) Patent Application Publication
(10) Pub. No.: US 2014/0045975 A1
(43) Pub. Date: Feb. 13, 2014

(54) METHOD OF PREPARING CROSS-LINKED COLORANT DISPERSIONS

(71) Applicants: James A. Silver, Kennett Square, PA (US); Christian Jackson, Wilmington, DE (US); Anthony W. Kluth, Villanova, PA (US); Xiaoqing Li, Newark, DE (US); Richard C. Sonntag, Swarthmore, PA (US)

(72) Inventors: James A. Silver, Kennett Square, PA (US); Christian Jackson, Wilmington, DE (US); Anthony W. Kluth, Villanova, PA (US); Xiaoqing Li, Newark, DE (US); Richard C. Sonntag, Swarthmore, PA (US)

(73) Assignee: E I DU PONT DE NEMOURS AND COMPANY, Wilmington, DE (US)

(21) Appl. No.: 14/112,990

(22) PCT Filed: Apr. 30, 2012
(86) PCT No.: PCT/US2012/035901

§ 371 Date: Oct. 21, 2013

Related U.S. Application Data
(60) Provisional application No. 61/480,612, filed on Apr. 29, 2011.

(51) Int. Cl. C09D 11/00

(52) U.S. Cl. CPC C09D 11/30
USPC 523/402

(57) ABSTRACT

A process for preparing a crossed-linked colorant dispersion is provided in which a pigment and a dispersant polymer having a cross-linkable moiety are subjected to micromedia milling followed by a purification step to remove small pigment particles before reacting the cross-linkable moiety on the dispersant polymer with a cross-linking agent. Also disclosed is the use of dispersions made from this process in ink jet inks.

### CROSS REFERENCE TO RELATED APPLICATIONS

This application claims priority under 35 U.S.C. §119 from U.S. Provisional Application Ser. Nos. 61/480,612 and 61/480,619, filed Apr. 29, 2011.

### BACKGROUND OF THE INVENTION

This invention relates to a process of making crossed-linked dispersions, especially aqueous crossed-linked colorant dispersions. Also disclosed is the use of these dispersions in ink-jet inks.

Aqueous dispersions of pigments are widely used in ink-jet printing. Because a pigment is typically not soluble in an aqueous vehicle, it is often required to use a dispersing agent, such as a polymeric dispersant or a surfactant, to produce a stable dispersion of the pigment in the aqueous vehicle.

Conventional dispersants are adsorbed onto the surface of the particulate solid by physical interactions. Many conventional dispersants suffer from a disadvantage in that they may readily be displaced from the surface of the particulate solid by a more strongly adsorbing or displacing material resulting in destabilization of the dispersion and flocculation. The stability of pigment dispersions can be improved by cross-linking the dispersant on the surface of the pigment particle so that it forms a network that will not desorb and cannot be displaced by other molecules such as surfactants. The Cross-linked pigment dispersions thus obtained can be used in a wide range of solvents and surfactants without significant loss of stability.

Media milling of pigment dispersions with micromedia has a number of advantages including producing small particle size pigment dispersions with few large particles or aggregates, having little contamination from the media, and having reduced settling of the pigment dispersions. However, this form of milling can also fragment the primary pigment particles producing a small concentration of very small pigment particles or “fines”. If the concentration of “fines” becomes significant in the milling process, the stability of the cross-linked dispersions is greatly reduced. Furthermore, the “fines” in a ink jet ink correlate with long term reliability problems such as kogation of the resistor in thermal ink-jet during printing and puddling of the nozzle plate leading to mis-directed jetting.

Various dispersion processes are known. A two-roll milling process of dispersing pigments using polymeric dispersants is disclosed in U.S. Pat. No. 5,310,778. A process where a combination of solvents is used and a polymeric dispersant is precipitated from the solvent mixture onto the finely dispersed pigment particles is disclosed in U.S. Pat. No. 6,923,045. European Patent No. 1940980 describes a process for purifying a composition of encapsulated pigment by removing some free dispersant after cross-linking.

A need exists for an easy-to-operate, more effective, and lower cost process for making stable colorant dispersions while maintaining the benefits of micromedia milling. The present invention satisfies this need by providing a process for making a cross-linked colorant dispersion by using a purification process prior to cross-linking to remove small pigment particles and thus avoid the problems relating to these small pigment particles.

### SUMMARY OF THE INVENTION

An embodiment of the invention provides a process for making a cross-linked pigment dispersion comprising the steps of:
(a) mixing a pigment, a dispersant polymer having a cross-linkable moiety, and an aqueous vehicle to form a premix;
(b) milling the premix with media beads less than 0.55 mm in diameter to form a dispersion;
(c) filtering the dispersion using a cross-flow membrane with pore size greater than or equal to 0.2 microns or greater than 20 times the volumetric average of pigment particle size; and
(d) reacting the cross-linkable moiety on the dispersant polymer with a cross-linking agent.

Another embodiment provides that the dispersant polymer is a polymer selected from the group consisting of polyurethane, polyvinyl and polyester.

Another embodiment provides that the cross-linking agent is one or more members selected from the group consisting of epoxide, isocyanate, carbodiimide, N-methylol, oxazoline, silane, and mixtures thereof.

Another embodiment provides that the dispersant polymer is polyurethane.

Another embodiment provides that the cross-linking agent is an epoxide.

Another embodiment provides that the membrane has a pore size of greater than or equal to 0.3 microns.

Another embodiment provides that the content of particles with a diameter of less than 50 nm is less than 20% by weight after step (c).

Another embodiment provides that the content of particles with a diameter of less than 50 nm is less than 10% by weight after step (c).

Another embodiment provides that the cross-linkable moiety on the dispersant polymer is one or more members selected from the group consisting of acid, hydroxyl, amino, and mixtures thereof.

Another embodiment provides that the media beads have a diameter of less than 0.4 mm.

Another embodiment provides that the process further comprises a step of purifying the dispersion by ultrafiltration after step (d).

Another embodiment provides that the cross-linking agent is an isocyanate.

Another embodiment provides a process for making a cross-linked pigment dispersion consisting the steps of:
(a) mixing a pigment, a dispersant polymer having a cross-linkable moiety, and an aqueous vehicle to form a premix;
(b) milling the premix with media beads less than 0.55 mm in diameter to form a dispersion;
(c) filtering the dispersion using a cross-flow membrane with pore size greater than or equal to 0.2 microns or greater than 20 times the volumetric average of pigment particle size; and
(d) reacting the cross-linkable moiety on the dispersant polymer with a cross-linking agent.

Another embodiment provides a process for making a cross-linked pigment dispersion consisting the steps of:
(a) mixing a pigment, a dispersant polymer having a cross-linkable moiety, and an aqueous vehicle to form a premix;
(b) milling the premix with media beads less than 0.55 mm in diameter to form a dispersion;
(c) filtering the dispersion using a cross-flow membrane with pore size greater than or equal to 0.2 microns or greater than 20 times the volumetric average of pigment particle size;
(d) reacting the cross-linkable moiety on the dispersant polymer with a cross-linking agent; and
(e) purifying the dispersion by ultrafiltration.

Another embodiment provides an aqueous dispersion comprising a cross-linked pigment dispersion, wherein the cross-linked pigment dispersion is obtainable by the steps of:
(a) mixing a pigment, a dispersant polymer having a cross-linkable moiety, and an aqueous vehicle to form a premix;
(b) milling the premix with media beads less than 0.55 mm in diameter to form a dispersion;
(c) filtering the dispersion using a cross-flow membrane with pore size greater than or equal to 0.2 microns or greater than 20 times the volumetric average of pigment particle size; and
(d) reacting the cross-linkable moiety on the dispersant polymer with a cross-linking agent.

Another embodiment provides an aqueous ink comprising the aqueous dispersion as set forth above.

Another embodiment provides that the aqueous ink is printed on paper.

Yet another embodiment provides that the aqueous ink is printed on textile.

These and other features and advantages of the present invention will be more readily understood by those of ordinary skill in the art from a reading of the following Detailed Description. Certain features of the invention which are, for clarity, described above and below as a separate embodiment, may also be provided in combination in a single embodiment. Conversely, various features of the invention that are described in the context of a single embodiment, may also be provided separately or in any subcombination.

### DETAILED DESCRIPTION

Unless otherwise stated or defined, all technical and scientific terms used herein have commonly understood meanings by one of ordinary skill in the art to which this invention pertains.

Unless stated otherwise, all percentages, parts, ratios, etc., are by weight.

When an amount, concentration, or other value or parameter is given as either a range, preferred range or a list of upper preferable values and lower preferable values, this is to be understood as specifically disclosing all ranges formed from any pair of any upper range limit or preferred value and any lower range limit or preferred value, regardless of whether ranges are separately disclosed. Where a range of numerical values is recited herein, unless otherwise stated, the range is intended to include the endpoints thereof, and all integers and fractions within the range.

When the term “about” is used in describing a value or an end-point of a range, the disclosure should be understood to include the specific value or end-point referred to.

As used herein, the dispersions produced with the dispersant polymer described above can be utilized to disperse particles, especially pigments for ink-jet inks. These inks can be printed on all normally used ink jet substrates including plain paper, photo paper, paper for network and commercial printing, and textile substrates.

As used herein, the term “dispersion” means a two phase system where one phase consists of finely divided particles (often in the colloidal size range) distributed throughout a bulk substance, of the particles being the dispersed or internal phase and the bulk substance being the continuous or external phase.

As used herein, the term “dispersant” means a surface active agent added to a suspending medium to promote uniform and maximum separation of extremely fine solid particles often of colloidal size. For pigments, dispersants are most often polymeric dispersants.

As used herein, the term “P/D” means the ratio between a pigment and a dispersant.

As used herein, the term “aqueous vehicle” refers to water or a mixture of water and at least one water-soluble, or partially water-soluble (i.e. methyl ethyl ketone), organic solvent (co-solvent).

As used herein, the term “Mw” means weight average molecular weight.

As used herein, the term “Mn” means number average molecular weight.

As used herein, the term “D50” means the volume particle diameter of the 50th percentile (median) of the distribution of particle sizes.

As used herein, the term ‘D95’ means the volume particle diameter of the 95th percentile of the distribution of particle sizes.

As used herein, the term “cPs” means centipoise, a viscosity unit.

As used herein, the term “mN·m-1” means milliNewtons per meter, a surface tension unit.

As used herein, the term “mPa·s” means millipascal second, a viscosity unit.

As used herein, the term “AN” means acid number, mg KOH/gram of solid polymer.

As used herein, the term “DBTDL” means dibutyltin dilaurate.

As used herein, the term “DEA” means diethanolamine.

As used herein, the term “TBA” means tributyl amine.

As used herein, the term “DMPA” means dimethylol propionic acid.

As used herein, the term “TMXDI” means m-tetramethylene xylylene diisocyanate.

As used herein, the term “IPDI” means isophorone diisocyanate.

As used herein, the term “Sulfolane” means tetramethylene sulfone.

As used herein, the term “BzMA” means benzyl methacrylate.

As used herein, Denacol® 321 is trimethylolpropane polyglycidyl ether, a cross-linking reagent from Nagase Chemicals Ltd., Osaka, Japan.

As used herein, the term “BMEA” means bis(methoxyethyl)amine.

As used herein, the term “EDA” means ethylenediamine.

As used herein, Tergitol® 15-S-7 is a secondary alcohol ethoxylate from Dow Chemical Company, Midland, Mich.

Unless otherwise noted, the above chemicals were obtained from Aldrich (Milwaukee, Wis.) or other similar suppliers of laboratory chemicals.

In addition, references in the singular may also include the plural (for example, “a” and “an” may refer to one, or one or more) unless the context specifically states otherwise.

An embodiment of the invention provides a process for making a cross-linked pigment dispersion comprising the steps of:
(a) mixing a pigment, a dispersant polymer having a cross-linkable moiety, and an aqueous vehicle to form a premix;
(b) milling the premix with media beads less than 0.55 mm in diameter to form a dispersion;
(c) filtering said dispersion using a cross-flow membrane with pore size greater than or equal to 0.2 microns or greater than 20 times the volumetric average of pigment particle size; and
(d) reacting said cross-linkable moiety on the dispersant polymer with a cross-linking agent.

In Step (a), a pigment, a dispersant polymer, an aqueous vehicle, and any optional additives are blended to provide a “premix”. Typically all liquid ingredients are added first, followed by the dispersant, and lastly the pigment. Mixing is generally done in a stirred mixing vessel, and a high-speed disperser (HSD) is particularly suitable for the mixing step. A Cowels type blade attached to the HSD and operated at from 500 rpm to 4000 rpm, and more typically from 2000 rpm to 3500 rpm, provides optimal shear to achieve the desired mixing. Adequate mixing is usually achieved after mixing under the conditions described above for a period of from 15 to 120 minutes.

Suitable dispersant polymer in Step (a) includes polyurethane, acrylics, polyester and polyvinyl. Both random and structured polymers can be used. The term “structured polymer” refers to polymers having a block, branched or graft structure. Examples of structured polymers include AB or BAB block copolymers such as disclosed in U.S. Pat. No. 5,085,698; ABC block copolymers such as disclosed in EP-A-0556649; and graft polymers such as disclosed in U.S. Pat. No. 5,231,131. It should be noted that, in referring to the polymer compositions, a double slash indicates a separation between blocks and a single slash indicates a random copolymer. Thus, BzMA//MAA//BzMA 8//10//8 is an ABA triblock polymer with a first A block that is on average 8 BzMA (Benzyl Methacrylate) units long, a B block that is on average 10 MAA (Methacrylic Acid) units long, and a final A block that is on average 8 BZMA units long. Other suitable polymers include, for example, the ones described in U.S. Pat. Nos. 5,085,698; 5,852,075; 6,117,921; 6,262,152; 6,306,994; and 6,433,117.

In Step (b), the premix from step (a) is milled with media beads less than 0.55 mm in diameter to form a dispersion. Typically, a lab-scale Eiger Minimill (Model M250, VSE EXP) manufactured by Eiger Machinery Inc., Chicago, Ill. is employed. Grinding/milling was accomplished by charging about 820 grams of 0.5 YTZ® zirconia media to the mill. The mill disk is operated at a speed between 2000 rpm and 4000 rpm, and typically between 3000 rpm and 3500 rpm. The dispersion is processed using a re-circulation grinding process with a typical flow rate through the mill at between 200 to 500 grams/minute, and more typically at 300 grams/minute. The milling may be done using a staged procedure in which a fraction of the solvent is held out of the grind and added after milling is completed. This is done to achieve optimal rheology that maximizes grinding efficiency. The amount of solvent held out during milling varies by dispersion, and is typically between 200 to 400 grams for a batch size with a total of 800 grams. Typically, the dispersions of the present invention are subjected to a total of 4 hours of milling when an Eiger Minimill is used.

Alternatively, a lab-scale Buhler Mill (Model MMP1) manufactured by Buhler Inc., Minneapolis, Minn. is employed. Grinding/milling was accomplished by charging about 3.8 kilograms of 0.2 mm YTZ® zirconia media to the mill. The mill disk is operated at a speed between 1000 rpm and 1500 rpm, and typically between 1250 rpm and 1450 rpm. The dispersion is processed using a re-circulation grinding process with a typical flow rate through the mill at between 2.0 to 3.5 liters/minute, and more typically at 3.1 liters/minute. Typically, the dispersions of the present invention are subjected to a total of 40 minutes of milling when a Buhler Mill is used.

For black dispersions, an alternate milling process using a Microfluidizer can be used. Microfluidization is a non-media milling process in which milling is done by pigment impingement through nozzles under high pressures. Typically, pigment dispersions are processed at 15,000 psi with a flow rate of 400 grams/minute for a total of 12 passes through the mill.

In step (c), the dispersion from step (b) is purified by using a cross-flow membrane to remove the very small pigment particles resulting from the milling process in step (b). The inventors found that these very small pigment particles, or “fines”, correlate long term reliability problems such as kogation of the resistor in thermal ink-jet during printing and nozzle plate puddling leading to mis-directed jetting. Although the removal of very small pigment particles has a negative impact on yield, the long term stability of the pigment dispersion is greatly improved. Typically, the membrane has a pore size greater than or equal to 0.2 microns or greater than 20 times the volumetric average of pigment particle size. It is noteworthy that some of the free dispersant is also removed during step (c), since the membrane employed has pore size larger than the size of the dispersant. The ultrafiltration process typically involves a continuous diafiltration with de-ionized water. Often the dispersion is diluted to less than 5% pigment concentration with deionized water before diafiltration begins. Optionally, the dispersion is concentrated to greater than 10% pigment.

In step (d), the product of step (c) is reacted with a cross-linking agent. Identified in the table below are suitable cross-linkable functional groups that are in the dispersant polymer and the companion cross-linking groups that may be present in the cross-linking agent. The “Acid” referred to in the table below includes, but are not limited to, carboxylic acid and sulfonic acid.

| Cross-linkable Moieties | Cross-linking Groups |
|---|---|
| Acid | Epoxide, Carbodiimide, Oxazoline, N-Methyol |
| Hydroxyl | Epoxide, Silane, Isocyanate, N-Methyol |
| Amino | Epoxide, Carbodiimide, Oxazoline, N-Methyol |

Additional useful cross-linking agents are those which are soluble or insoluble in the aqueous vehicle, including m-tetramethylxylene diisocyanate (TMXDI), isophorone diisocyanate (IPDI), trimethylopropane polyglycidyl ether, polyglycerol polyglycidyl ether, oxazoline-functional polymers, waterborne polycarbodiimide resin, and silane.

The mole ratio of the cross-linkable moiety on the dispersant polymer to the cross-linking agent is from 15:1 to 1:1.5, typically from 9:1 to 1:1.1, and most typically from 8:1 to 1:1. In calculating the mole ratio, all cross-linkable moieties on the dispersant polymer and all cross-linking groups on the cross-linking agent are included.

Typically, a cross-linking compound is mixed with the pigmented dispersions prepared above at room temperature or elevated temperature for a period from 4 h to 8 h. To facilitate the cross-linking reaction, it may be desirable to add a catalyst. Useful catalysts can be those that are either soluble or insoluble in the liquid and can be selected depending upon the cross-linking reactions. Some suitable catalysts include dibutyltin dilaurate (DBTDL), tributyl amine (“TBA”) and dimethyldodecyl amine. After the cross-linking reaction is completed, the pH of the cross-linked dispersion can be adjusted to at least about 8.0, more typically to between 8.0 and 12.0, and most typically between 8.0 and 11.0, if needed.

Optionally, the dispersion is further purified by an ultrafiltration step after step (d). The ultrafiltration can be carried out on any conventional cross-flow, hollow fiber membrane. Typically, the membrane has a fiber with inner diameter greater than 0.75 mm, more typically greater than 1 mm. Typically, the membrane has a pore size less than 0.2 microns or less than 20 times the volumetric average of pigment particle size. Suitable commercially available materials for constructing the membrane include polyethylene, polypropylene, polysulfone, polyvinylidene fluoride, and ceramic.

### Colorants

A wide variety of organic and inorganic pigments, alone or in combination, may be dispersed with the dispersant polymer to prepare an ink, especially an ink-jet ink. The term “pigment” as used herein means an insoluble colorant that is required to be dispersed with a dispersant and processed under dispersive conditions in the presence of a dispersant. The colorant also includes dispersed dyes. The dispersion process results in a stable dispersed pigment. The pigment used with the inventive dispersant polymer does not include self-dispersed pigments. The pigment particles are sufficiently small to permit free flow of the ink through the ink jet printing device, especially at the ejecting nozzles that usually have a diameter ranging from about 10 micron to about 50 micron. The particle size also has an influence on the pigment dispersion stability, which is critical throughout the life of the ink. Brownian motion of minute particles will help prevent the particles from flocculation. It is also desirable to use small particles for maximum color strength and gloss. The range of useful particle size is typically about 0.005 micron to about 15 micron. Typically, the pigment particle size should range from about 0.005 to about 5 micron and, most typically, from about 0.005 to about 1 micron. The average particle size as measured by dynamic light scattering is less than about 500 nm, typically less than about 300 nm.

The selected pigment(s) may be used in dry or wet form. For example, pigments are usually manufactured in aqueous media, and the resulting pigments are obtained as a water-wet presscake. In presscake form, the pigment does not agglomerate to the extent as in dry form. Thus, pigments in water-wet presscake form do not require as much mixing energy to de-agglomerate in the premix process as pigments in dry form. Representative commercial dry pigments are listed in U.S. Pat. No. 5,085,698.

Some examples of pigments with coloristic properties useful in inkjet inks include: cyan pigments from Pigment Blue 15:3 and Pigment Blue 15:4; magenta pigments from Pigment Red 122 and Pigment Red 202; yellow pigments from Pigment Yellow 14, Pigment Yellow 95, Pigment Yellow 110, Pigment Yellow 114, Pigment Yellow 128 and Pigment Yellow 155; red pigments from Pigment Orange 5, Pigment Orange 34, Pigment Orange 43, Pigment Orange 62, Pigment Red 17, Pigment Red 49:2, Pigment Red 112, Pigment Red 149, Pigment Red 177, Pigment Red 178, Pigment Red 188, Pigment Red 255 and Pigment Red 264; green pigments from Pigment Green 1, Pigment Green 2, Pigment Green 7 and Pigment Green 36; blue pigments from Pigment Blue 60, Pigment Violet 3, Pigment Violet 19, Pigment Violet 23, Pigment Violet 32, Pigment Violet 36 and Pigment Violet 38; white pigments such as TiO₂ and ZnO; and black pigment carbon black. The pigment names and abbreviations used herein are the “C.I.” designation for pigments established by Society of Dyers and Colourists, Bradford, Yorkshire, UK and published in The Color Index, Third Edition, 1971.

In the case of organic pigments, the ink may contain up to approximately 30%, typically from 0.1% to about 25%, and more specifically from 0.25% to 10% of pigment, by weight based on the total ink weight. If an inorganic pigment is selected, the ink will tend to contain higher percentages by weight of pigment than with comparable inks employing organic pigment, since inorganic pigments generally have higher densities than organic pigments.

### Ink Vehicle

The pigmented ink of this disclosure comprises an ink vehicle typically an aqueous ink vehicle, also known as an aqueous carrier medium, the aqueous dispersion and optionally other ingredients.

The ink vehicle is the liquid carrier (or medium) for the aqueous dispersion(s) and optional additives. The term “aqueous ink vehicle” refers to an ink vehicle comprised of water or a mixture of water and one or more organic, water-soluble vehicle components commonly referred to as co-solvents or humectants. Selection of a suitable mixture depends on requirements of the specific application, such as desired surface tension and viscosity, the selected pigment, drying time of the pigmented ink jet ink, and the type of paper onto which the ink will be printed. Sometimes in the art, when a co-solvent can assist in the penetration and drying of an ink on a printed substrate, it is referred to as a penetrant.

Examples of water-soluble organic solvents and humectants include: alcohols, ketones, keto-alcohols, ethers and others, such as thiodiglycol, Sulfolane, 2-pyrrolidone, 1,3-dimethyl-2-imidazolidinone and caprolactam; glycols such as ethylene glycol, diethylene glycol, triethylene glycol, tetraethylene glycol, propylene glycol, dipropylene glycol, tripropylene glycol, trimethylene glycol, butylene glycol and hexylene glycol; addition polymers of oxyethylene or oxypropylene such as polyethylene glycol, polypropylene glycol and the like; triols such as glycerol and 1,2,6-hexanetriol; lower alkyl ethers of polyhydric alcohols, such as ethylene glycol monomethyl ether, ethylene glycol monoethyl ether, diethylene glycol monomethyl, diethylene glycol monoethyl ether; lower dialkyl ethers of polyhydric alcohols, such as diethylene glycol dimethyl or diethyl ether; urea and substituted ureas.

A mixture of water and a polyhydric alcohol, such as diethylene glycol, is typical as the aqueous ink vehicle. In the case of a mixture of water and diethylene glycol, the ink vehicle usually contains from 30% water and 70% diethylene glycol to 95% water and 5% diethylene glycol, more typically from 60% water and 40% diethylene glycol to 95% water and 5% diethylene glycol. Percentages are based on the total weight of the ink vehicle. A mixture of water and butyl carbitol is also an effective ink vehicle.

The amount of ink vehicle in the ink is typically in the range of from 70% to 99.8%, and more typically from 80% to 99.8%, by weight based on total weight of the ink.

The ink vehicle can be made to be fast penetrating (rapid drying) by including surfactants or penetrating agents such as glycol ethers and 1,2-alkanediols. Glycol ethers include ethylene glycol monobutyl ether, diethylene glycol mono-n-propyl ether, ethylene glycol mono-iso-propyl ether, diethylene glycol mono-iso-propyl ether, ethylene glycol mono-n-butyl ether, ethylene glycol mono-t-butyl ether, diethylene glycol mono-n-butyl ether, triethylene glycol mono-n-butyl ether, diethylene glycol mono-t-butyl ether, 1-methyl-1-methoxybutanol, propylene glycol mono-t-butyl ether, propylene glycol mono-n-propyl ether, propylene glycol mono-iso-propyl ether, propylene glycol mono-n-butyl ether, dipropylene glycol mono-n-butyl ether, dipropylene glycol mono-n-propyl ether, and dipropylene glycol mono-isopropyl ether. Typical 1,2-alkanediols are C₄-C₆ alkanediols with 1,2-hexanediol being most typical. Suitable surfactants include ethoxylated acetylene diols (e.g. Surfynol® series commercially available from Air Products), ethoxylated alkyl primary alcohols (e.g. Neodol® series commercially available from Shell) and secondary alcohols (e.g. Tergitol® series commercially available from Union Carbide), sulfosuccinates (e.g. Aerosol® series commercially available from Cytec), organosilicones (e.g. Silwet® series commercially available from Witco) and fluoro surfactants (e.g. Zonyl® series commercially available from DuPont).

The amount of glycol ether(s) and 1,2-alkanediol(s) added is typically in the range of from 1% to 15%, and more typically from 2% to 10% by weight, based on the total weight of the ink. Surfactants may be used, typically in the amount of from 0.01% to 5% and more typically from 0.2% to 2%, by weight based on the total weight of the ink.

Biocides may be used to inhibit growth of microorganisms.

The dispersant polymer is typically present in the range of from 0.1% to 20%, and more specifically from 0.2% to about 10%, by weight based on the weight of the total ink composition.

Fillers, plasticizers, pigments, carbon black, silica sols, other polymer dispersions and the known leveling agents, wetting agents, antifoaming agents, stabilizers, and other additives known for the desired end use, may also be incorporated into the dispersions.

Pigmented ink jet inks typically have a surface tension in the range of about 20 mN·m⁻¹ to about 70 mN·m⁻¹, at 25° C. Viscosity can be as high as 30 mPa·s at 25° C., but is typically somewhat lower. The ink has physical properties compatible with a wide range of ejecting conditions, materials construction and the shape and size of the nozzle. The inks should have excellent storage stability for long periods so as not to clog to a significant extent in an ink jet apparatus. Further, the ink should not corrode parts of the ink jet printing device it comes in contact with, and it should be essentially odorless and non-toxic.

Although not restricted to any particular viscosity range or printhead, the inks of the disclosure are particularly suited to lower viscosity applications. Thus the viscosity (at 25° C.) of the inks of this disclosure may be less than about 7 mPa·s, or less than about 5 mPa·s, and even more advantageously, less than about 3.5 mPa·s

The following examples illustrate the invention without, however, being limited thereto.

### EXAMPLES

Standard laboratory techniques for handling water sensitive chemicals were employed for the following examples. For example, glassware was extensively dried before use, monomers were stored over molecular sieves, and cannulation procedures were used to keep material dry.

Gel Permeation Chromatography (GPC) was used to verify the predicted molecular weight and molecular weight distribution. The GPC system included a Waters 1515 Isocratic HPLC Pump, a Waters 2414 Refractive Index Detector, a Waters Autosampler, and a Waters Column Heater set at 40° C. and containing 4 Styregel columns (HR 0.5, HR 1, HR 2, and HR 4). Samples were eluted with tetrahydrofuran (THF) at a flow rate of 1 mL/min. The samples were analyzed using Breeze 3.30 Software with a calibration curve developed from polymethylmethacrylate (PMMA) standards with narrow molecular weight range. Based on light scattering data provided by Polymer Laboratories Ltd., the nominal, peak molecular weight for the PMMA standards were as follows: 300000, 150000, 60000, 30000, 13000, 6000, 2000, and 1000.

### Particle Size Measurements

The particle size for the dispersions, pigments and the inks were determined by dynamic light scattering using a Microtrac® UPA 150 analyzer from Honeywell/Microtrac (Montgomeryville, Pa.).

This technique is based on the relationship between the velocity distribution of the particles and the particle size. Laser generated light is scattered from each particle and is Doppler shifted by the particle Brownian motion. The frequency difference between the shifted light and the unshifted light is amplified, digitalized and analyzed to derive the particle size distribution. Results are reported as D50 or D95.

### Determination of Content of Fine Pigment Particles

To determine the content of fine pigment particles in a dispersion, a sample of the dispersion is diluted with de-ionized water to the extent of having about 5% of colorant by weight. Typically, a 25 gram sample of this diluted dispersion is centrifuged at between 15,000 to 20,000 rpm for a period of 1-2 hours using a Beckman L-8 Ultracentrifuge. One skilled in the art can easily determine the optimal conditions for the centrifugation based on the properties of the dispersion. During centrifugation, the un-adsorbed dispersant polymer and fine pigment remain in the supernatant whereas most of the pigment, together with the adsorbed dispersant polymer on the pigment surface, deposits towards the bottom. After centrifugation, the supernatant is collected and the total amount of fine pigment in the supernatant is determined by visible absorbance. Calibration of the visible absorbance is done by using known concentrations of the milled pigment prior to any membrane filtration purification step. The amount of pigment in the supernatant is then divided by the weight of pigment in the diluted sample subjected to centrifugation to give the percentage of fine pigment particles.

### Dispersant A

To a dry, alkali- and acid-free flask equipped with an additional funnel, a condenser and a stirrer, under a nitrogen atmosphere was added Terathane® 650 (155 g), DMPA (54 g), Sulfolane (237 g) and DBTL (0.06 g). The resulting mixture was heated to 60° C. and thoroughly mixed. To this mixture was added IDPI (157 g) via the additional funnel mounted on the flask followed by rinsing any residual IDPI in the additional funnel into the flask with Sulfolane (15 g). The temperature for the reaction mixture was raised to 85° C. and maintained at 85° C. until the isocyanate content reached 1.2% or below. The temperature was then cooled to 60° C. and maintained at 60° C. while BMEA (17.5 g) was added via the additional funnel over a period of 5 minutes followed by rinsing the residual DEA in the additional funnel into the flask with Sulfolane (5 g). After holding the temperature for 1 hr at 60° C., aqueous KOH (526.5 g, 3% by weight) was added over a period of 10 minutes via the additional funnel followed by de-ionized water (356 g). The mixture was maintained at 60° C. for 1 hr and cooled to room temperature to provide Dispersant A, a polyurethane dispersant with 20.16% of solids having an acid number of 80 mg/KOH and a MN of 6000.

### Dispersant B

To a dry, alkali- and acid-free flask equipped with an additional funnel, a condenser and a stirrer, under a nitrogen atmosphere was added Eternacoll® UH-50 (275 g), DMPA (200 g), Sulfolane (526 g) and DBTL (0.08 g). The resulting mixture was heated to 60° C. and thoroughly mixed. To this mixture was added TMXDI (547 g) via the additional funnel followed by rinsing any residual TMXDI in the additional funnel into the flask with Sulfolane (15 g). The temperature for the reaction mixture was raised to 100° C. and maintained at 100° C. until the isocyanate content reached 1.2% or below. Then additional Sulfolane (600 g) was added and EDA (5.9 g) was added after temperature was cooled to 85° C. The temperature was then raised and maintained at 95° C. for 30minutes. DEA (20.7 g) was then added. After the temperature was hold at 95° C. for another 30 minutes, aqueous KOH solution (718.5 g, 3% by weight) was added over a period of 10 minutes via the additional funnel followed by de-ionized water (881 g). The mixture was maintained at 60° C. for 1 hr and cooled to room temperature to provide Dispersant B, a polyurethane dispersant with 29% solids. This dispersant has a MN of 10000, MW of 24000, an acid number of 80 mg/KOH, and a PD of 2.4.

### Dispersant C

To a dry, alkali- and acid-free flask equipped with an additional funnel, a condenser and a stirrer, under a nitrogen atmosphere was added Terathane® 650 (156 g), DMPA (94.4 g), Sulfolane (220 g) and DBTL (0.06 g). The resulting mixture was heated to 60° C. and thoroughly mixed. To this mixture was added TMXDI (236 g) via the additional funnel mounted on the flask followed by rinsing any residual TMXDI in the additional funnel into the flask with Sulfolane (15 g). The temperature for the reaction mixture was raised to 100° C. and maintained at 100° C. until the isocyanate content reached 1.2% or below. The temperature was then cooled to 90° C. and maintained at 90° C. while Tergitol 15-S-7 (65.7 g) and BMEA (0.6 g) were added via the additional funnel over a period of 5 minutes followed by rinsing with Sulfolane (5 g). After holding the temperature for 60 minutes at 90° C., aqueous KOH (637 g, 3% by weight) was added over a period of 10 minutes via the additional funnel followed by de-ionized water (402 g). The mixture was maintained at 60° C. for 1 hr and cooled to room temperature to provide Dispersant C, a polyurethane dispersant with 29.6% of solids having an acid number of 70 mg/KOH.

### Preparation of Pigmented Dispersions

Pigmented dispersions were prepared using the three dispersants prepared above with Pigment Red 122. Dispersion A was prepared using Dispersant A at a Pigment/Dispersant ratio of 3 using a mini-media mill. Dispersion B was prepared using Dispersant B at a Pigment/Dispersant ratio of 3 using a Buhler mill with 0.2 mm media. Dispersion B had a high level of small pigment particles that could be detected in the supernatant after centrifugation of the dispersion. Dispersion C was prepared at a Pigment/Dispersant ratio of 4 using a Buhler mill with 0.2 mm media. Dispersion C also had a high level of fine particles that could be detected in the supernatant after centrifugation of the dispersion.

### Preparation of Cross-Linked Pigment Dispersions

In the cross-linking step, a cross-linking compound was mixed with Pigmented Dispersion A, B or C, and heated between 60° C. and 80° C. with efficient stirring for between 6 to 8 hours. After the cross-linking reaction was completed, the pH was adjusted to at least about 8.0 if needed. Crossed-linked Pigment Dispersions A1-A3, B2-B3, and C1-C2 were prepared using the corresponding Pigmented Dispersions A, B and C. Additional details on each cross-linked pigment dispersion follows:

### Cross-Linked Dispersion A1

Dispersion A was cross-linked without any prior micro- or ultrafiltration to remove any excess free dispersant or small particles. The cross-linker was a multifunctional epoxide (Denacol 321) and was added at a quantity that resulted in enough epoxide groups to react with 20% of the acid groups on the dispersant. After cross-linking, the dispersion was washed with six volume dilutions of de-ionized water using a microfiltration membrane having a 0.2 micron cutoff to remove any excess free dispersant and small particles.

### Cross-Linked Dispersion A2

Dispersion A was cross-linked after six volume dilutions of de-ionized water using an ultrafiltration membrane with a 300,000 molecular weight cutoff to remove any excess free dispersant and small particles. The cross-linker was a multifunctional epoxide (Denacol 321) and was added at a quantity that resulted in enough epoxide groups to react with 20% of the acid groups on the dispersant.

### Cross-Linked Dispersion A3

Dispersion A was cross-linked after six volume dilutions of de-ionized water using a microfiltration membrane with a 0.2 micron cutoff to remove any excess free dispersant and small particles. The cross-linker was a multifunctional epoxide (Denacol 321) and was added at a quantity that resulted in enough epoxide groups to react with 20% of the acid groups on the dispersant.

### Cross-Linked Dispersion B1

Dispersion B was washed with six volume dilutions of de-ionized water using a microfiltration membrane with a 0.2 micron cutoff to remove free dispersant and small particles before cross-linked with 3.5% of Denacol 321 on 100% pigment. Measured fines were 32% of total pigment in the supernatant.

### Cross-Linked Dispersion B2

Dispersion B was washed with six volume dilutions of de-ionized water using a microfiltration membrane with a 0.2 micron cutoff to remove free dispersant and small particles followed by further washings with six volume dilutions microfiltration using a 0.45 micron. It was then cross-linked with 3.5% of Denacol 321 on 100% pigment. Measured fines were 18% of total pigment in the supernatant.

### Cross-Linked Dispersion B3

Dispersion B was washed with six volume dilutions of de-ionized water using a microfiltration membrane with a 0.2 micron cutoff to remove free dispersant and small particles followed by further washings with six volume dilutions microfiltration using a 0.65 micron. It was then cross-linked with 3.5% of Denacol 321 on 100% pigment.

### Cross-Linked Dispersion C1

Dispersion C was washed with six volume dilutions of de-ionized water using a microfiltration membrane with a 0.2 micron cutoff to remove free dispersant and small particles before cross-linked with 1.0% of Denacol 321 on 100% pigment.

### Cross-Linked Dispersion C2

Cross-linked Dispersion C1 was washed with six volume dilutions of de-ionized water using a microfiltration membrane with a 0.2 micron cutoff after the cross-linking step. The measured fines in the supernatant went from 8.8% to 9.8% of total pigment so there was no significant reduction in the small particles present.

### Example 1

### Significance of Microfiltration Before Cross-Linking

### Reliability Tests

Inks A1-A3 were made using Cross-linked Dispersions A1-A3 in a standard ink-jet vehicle containing 2-pyrrolidone, glycols and surfactants.

| | Ink A1 | Ink A2 | |
|---|---|---|---|
| Dispersion | (Comparative) | (Comparative) | Ink A3 |
| Cross-linked | 4.5% Pigment | — | — |
| Dispersion A1 | | | |
| Cross-linked | — | 4.5% Pigment | — |
| Dispersion A2 | | | |
| Cross-linked | — | — | 4.5% Pigment |
| Dispersion A3 | | | |

The inks were filled into cartridges and printed from an HP K550 printer. Nozzle plate puddling was visually evaluated by stopping the printer after it had printed 2 pages of a high density print target, removing the printhead, and observing it under a microscope.

The line width deviation is a measure of the misdirectionality of the jetted ink drops caused by the build up of liquid on the print face. Each filled cartridge was used to print a test pattern repeatedly until the cartridge was empty, after printing about 150 pages. For every tenth page, the mean width deviation of a hairline on the print target was measured using ImageXpert. This value was averaged over the entire test and reported in the table below. A value of less than 25 microns indicated the line was very sharp with few misplaced drops while higher values were indicative of misdirected drops.

| | Ink A1 | Ink A2 | |
|---|---|---|---|
| | (Comparative) | (Comparative) | Ink A3 |
| Line Width Deviation | Unable to | 69 | 6 |
| | complete test | | |
| Nozzle Plate Puddling | Severe | Yes | No |

Ink A1, made with Cross-linked Dispersion A1 that was microfiltered after cross-linking using a membrane with pore size of 0.2 micron, was unable to complete the print test due to clogging of the nozzles by nozzle plate puddling. Ink A2, made with Cross-linked Dispersion A2 that was microfiltered before cross-linking using a membrane with a 300,000 molecular weight cutoff, showed significant misdirectionality and moderate amount of nozzle plate puddling. Ink A3, made with Dispersion A3 that was microfiltered before cross-linking using a membrane with a pore size of 0.2 micron, printed extremely well with no nozzle plate puddling.

This example demonstrated the criticality of microfiltration to remove small pigment particles before cross-linking. The dispersant had a molecular weight of 6,000 g/mol and so should easily pass through a membrane with a molecular weight cut-off of 300,000 g/mol. However, the results showed that it is not the removal of free dispersant, but instead the removal of small pigment particles that improved the jetting reliability of inks made with the inventive process.

### Stability Tests

Inks A4-A6 were made with cross-linked Dispersions A1-A3 using the following vehicle listed in the table below which contains aggressive solvents that generally destabilize pigment dispersions. The initial particle sizes were measured, and the inks were placed in a an oven set at 60° C. for three days before the particle sizes were re-measured. The results summarized in the table below showed that Ink A6, made with the dispersion using the inventive process, showed slight improvement in stability.

| | Ink A4 | Ink A5 | Ink A6 |
|---|---|---|---|
| Dispersion | | | |
| Cross-linked Dispersion A1* | 3 | — | — |
| Cross-linked Dispersion A2* | — | 3 | — |
| Cross-linked Dispersion A3* | — | — | 3 |
| Butyl Cellusolve* | 10 | 10 | 10.5 |
| Butyl Carbitol* | 16 | 16 | 16 |
| Triethanol amine* | 0.25 | 0.25 | 0.2 |
| DI Water | Balance | Balance | Balance |
| | to 100% | to 100% | to 100% |
| Stability Results | | | |
| Initial Particle size | 104 | 120 | 133 |
| (Mean Volume in nm) | | | |
| Particle size after 3 days | 592 | 699 | 460 |
| in oven (Mean Volume in nm) | | | |

*percent by weight based on total weight of ink

### Example 2

### Effects of Microfiltration Before Cross-Linking

### Reliability Tests

Inks B1-B3 were made using Cross-linked Dispersions B1-B3 in a standard inkjet vehicle containing 2-pyrrolidone, glycols and surfactants. Cross-linked Dispersions B1-B3 were prepared from Dispersion B after subjecting it to microfiltration using membranes of various sizes as described above. Results summarized in the table below showed that Ink B1, where the precursor Dispersion B was purified by microfiltration using a 0.2 micron membrane, had acceptable reliability but did suffer from nozzle plate puddling. Inks B2 and B3, where the precursor Dispersion B was further purified by a microfiltration using a membrane of 0.45 micron and 0.65 micron, respectively, had much improved jetting reliability. These results showed that effective removal of small pigment particles, not just the free dispersant, greatly improved the reliability of the inks.

| | Ink B1 | Ink B2 | Ink B3 |
|---|---|---|---|
| Dispersion | | | |
| Cross-linked | 4.5% Pigment | — | — |
| Dispersion B1 | | | |
| Cross-linked | — | 4.5% Pigment | — |
| Dispersion B2 | | | |
| Cross-linked | — | — | 4.5% Pigment |
| Dispersion B3 | | | |
| Test Results | | | |
| Line Width Deviation | 53 | 22 | 35 |
| Nozzle Plate Puddling | Yes | No | Slight |

### Stability Tests

Inks B4-B7 were made with Dispersion B and cross-linked Dispersion B1-B3 using the vehicle listed in the table below which contains aggressive solvents that generally destabilize pigment dispersions. The initial particle sizes were measured, and the inks were placed in a an oven set at 60° C. for three days before the particle sizes were re-measured. The results summarized in the table below showed that the Ink B4, made with Dispersion B without any cross-linking, was immediately destabilized by the solvents and the dispersion has started to aggregate even before the ink was placed in the oven; Ink B5, with only 0.2 micron membrane microfiltration was initially stable due to the cross-linking, but aggregated after 3 days; Inks B6 and B7, with microfiltration using membranes of larger pore sizes to remove small pigment particles, were stable both initially and after 3 days in the oven.

| | Ink B4 | Ink B5 | Ink B6 | Ink B7 |
|---|---|---|---|---|
| Dispersion | | | | |
| Dispersion B | 3 | | | |
| Cross-linked Dispersion B1 | — | 3 | — | — |
| Cross-linked Dispersion B2 | — | — | 3 | — |
| Cross-linked Dispersion B3 | — | — | — | 3 |
| Butyl Cellusolve | 10 | 10 | 10 | 10 |
| Butyl Carbitol | 16 | 16 | 16 | 16 |
| Triethanol amine | 0.25 | 0.25 | 0.2 | 0.2 |
| DI Water | Balance | Balance | Balance | Balance |
| | to 100% | to 100% | to 100% | to 100% |
| Stability Results | | | | |
| Initial Particle size | 428 | 98 | 91 | 92 |
| (Mean Volume in nm) | | | | |
| Particle size after 3 days | 351 | 239 | 95 | 101 |
| in oven (Mean Volume in nm) | | | | |

* percent by weight based on total weight of ink

### Example 3

### Timing of Microfiltration

### Reliability Tests

Inks C1 and C2 were made using Cross-linked Dispersions C1 and C2 in a standard inkjet vehicle containing 2-pyrrolidone, glycols and surfactants. As shown in the table below, both inks jetted reliably with no misdirected drops or nozzle plate puddling.

| | Ink C1 | Ink C2 |
|---|---|---|
| Dispersion | | |
| Cross-linked Dispersion C1 | 4.5% Pigment | — |
| Cross-linked Dispersion C2 | — | 4.5% Pigment |
| Test Results | | |
| Line Width Deviation | 2 | 3 |
| Nozzle Plate Puddling | No | No |

### Stability Tests

Inks C3 and C4 were made with Cross-linked Dispersions C1 and C2 using the vehicle listed in the table below which contains aggressive solvents that generally destabilize pigment dispersions. The initial particle sizes were measured, and the inks were placed in a an oven set at 60° C. for three days before the particle sizes were re-measured.

| | Ink C3 | Ink C4 |
|---|---|---|
| Dispersion | | |
| Cross-linked Dispersion C1 | 3 | — |
| Cross-linked Dispersion C2 | — | 3 |
| Butyl Cellusolve | 10 | 10 |
| Butyl Carbitol | 16 | 16 |
| Triethanol amine | 0.25 | 0.25 |
| DI Water | Balance to 100% | Balance to 100% |
| Stability Results | | |
| Initial Particle size | 93 | 442 |
| (Mean Volume in nm) | | |
| Particle size after 3 days | 79 | 412 |
| in oven (nm) | | |

* percent by weight based on total weight of ink

As shown in the table above, Ink C3, made with Cross-linked Dispersion C1 incorporating a microfiltration prior to cross-linking, was stable while Ink C4, made with Cross-linked Dispersion C2 incorporating a microfiltration after cross-linking was unstable. This showed that removal of small pigment particles prior to cross-linking was critical for the stability of inks.

1. A process for making a cross-linked pigment dispersion comprising the steps of:
(a) mixing a pigment, a dispersant polymer having a cross-linkable moiety, and an aqueous vehicle to form a premix;
(b) milling the premix with media beads less than 0.55 mm in diameter to form a dispersion;
(c) filtering said dispersion using a cross-flow membrane with pore size greater than or equal to 0.2 microns or greater than 20 times the volumetric average of pigment particle size; and
(d) reacting said cross-linkable moiety on the dispersant polymer with a cross-linking agent.

2. The process of claim 1, wherein said dispersant polymer is a polymer selected from the group consisting of polyurethane, polyvinyl and polyester.

3. The process of claim 2, wherein said cross-linking agent is one or more members selected from the group consisting of epoxide, isocyanate, carbodiimide, N-methylol, oxazoline, silane, and mixtures thereof.

4. The process of claim 3, wherein said dispersant polymer is polyurethane.

5. The process of claim 4, wherein said cross-linking agent is an epoxide.

6. The process of claim 5, wherein said membrane has a pore size of greater than or equal to 0.3 microns.

7. The process of claim 6, wherein the content of particles with a diameter of less than 50 nm is less than 20% by weight after step (c).

8. The process of claim 7, wherein the content of particles with a diameter of less than 50 nm is less than 10% by weight after step (c).

9. The process of claim 8, wherein said cross-linkable moiety on the dispersant polymer is one or more members selected from the group consisting of acid, hydroxyl, amino, and mixtures thereof.

10. The process of claim 9, wherein said media beads have a diameter of less than 0.4 mm.

11. The process of claim 10, further comprises a step of purifying the dispersion by ultrafiltration after step (d).

12. The process of claim 4, wherein said cross-linking agent is an isocyanate.

13. The process of claim 12, wherein said membrane has a pore size of greater than or equal to 0.3 microns.

14. The process of claim 13, wherein the content of particles with a diameter of less than 50 nm is less than 20% by weight after step (c).

15. The process of claim 14, wherein said cross-linkable moiety on the dispersant polymer is one or more members selected from the group consisting of acid, hydroxyl, amino, and mixtures thereof.

16. The process of claim 15, further comprises a step of purifying the dispersion by ultrafiltration after step (d).

17. (canceled)

18. (canceled)

19. An aqueous dispersion comprising a cross-linked pigment dispersion, wherein said cross-linked pigment dispersion is obtainable by the steps of:
(a) mixing a pigment, a dispersant polymer having a cross-linkable moiety, and an aqueous vehicle to form a premix;
(b) milling the premix with media beads less than 0.55 mm in diameter to form a dispersion;
(c) filtering said dispersion using a membrane with pore size greater than or equal to 0.2 microns or greater than 20 times the volumetric average of pigment particle size; and
(d) reacting said cross-linkable moiety on the dispersant polymer with a cross-linking agent.

20. An aqueous ink jet ink comprising an aqueous dispersion, wherein said aqueous dispersion is comprised of a cross-linked pigment dispersion, wherein said cross-linked pigment dispersion is obtainable by the steps of:
(a) mixing a pigment, a dispersant polymer having a cross-linkable moiety, and an aqueous vehicle to form a premix;
(b) milling the premix with media beads less than 0.55 mm in diameter to form a dispersion;
(c) filtering said dispersion using a membrane with pore size greater than or equal to 0.2 microns or greater than 20 times the volumetric average of pigment particle size; and
(d) reacting said cross-linkable moiety on the dispersant polymer with a cross-linking agent.
